(19) United States
(12) Patent Application Publication
(10) Pub. No.: US 2007/0261309 A1
(43) Pub. Date: Nov. 15, 2007

(54) Automatic door assembly with telescoping door arm

(75) Inventors: Steven G. Tommell, Meriden, CT (US); Thomas M. Kowalczyk, Farmington, CT (US)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: The Stanley Works, New Britain, CT (US)

(21) Appl. No.: 11/430,929

(22) Filed: May 10, 2006

(51) Int. Cl. E05F 11/24

(52) U.S. Cl. 49/339

(57) ABSTRACT

The present application relates to an automatic door assembly with a door arm comprising at least two rectilinearly movable sections.

### FIELD OF THE INVENTION

The present application relates to an automatic door assembly with a door arm comprising at least two rectilinearly movable sections.

### BACKGROUND OF THE INVENTION

Automatic door assemblies, including those of the swing door type, are well-known in the art. With swing door assemblies, some type of arm is connected between the door panel and the output member of a door operator. The rotation of the output member under the power of the door operator pivots the arm, which is translated into swinging motion of the door panel.

The most common approach for these door arms is to use a rigid door arm of a fixed length. One end of the arm is connected to the operator output member, and the other end is connected to a sliding block. This sliding block is received on a rail or track mounted on the top of the door panel. These track and block constructions can often be noisy, as there may be play between the track and block due to tolerances. Also, these add extra costs in terms of both parts and assembly processes.

Another approach is the use of an arm comprising two sections pivoted together. One end is pivotally connected to the door panel, and the other end is fixed to the operator output member. With this approach, the door panel, door frame, and the two sections of the arm function somewhat like a four-bar linkage. The pivoting of the arm section connected to the output member articulates the arm so as to swing the door panel. This approach, however, has the shortcoming of not being aesthetically desirable. Specifically, for much of the door swing motion, the arm is bent out at an angle. It also introduces the presence of a pinch point at the joint between the two arm sections.

To avoid these disadvantages, the present invention endeavors to provide an improved door arm construction for controlling the movement of a door panel in an automatic door assembly.

### SUMMARY OF THE INVENTION

One aspect of the present invention provides an automatic door system comprising a frame; at least one door panel mounted to the frame for swinging movements between open and closed positions; and a door operator comprising a motor and a rotatable output member. The motor is operable to rotate the output member under power. A door arm has opposing first and second ends. The first end is fixedly connected to the rotatable output member of the door operator and the second end is pivotally connected at a fixed point on the door panel such that rotation of the output member by the operator pivots the door arm to move the door panel. The door arm comprises at least two arm sections mounted to one another for relative rectilinear movement so as to enable a length of the door arm between the rotatable output member and the fixed point on the door panel to adjust for accommodating movement of the door panel.

The use of this door arm eliminates the need for using other, less desirable structures, such as the track and block device or a hinged arm. This door arm is compact, quiet, and effective at transmitting the force to the door panel.

Other objects, features, and advantages of the present invention will become apparent from the following detailed description, the accompanying drawings, and the appended claims.

### BRIEF DESCRIPTION OF THE DRAWINGS

FIG. 1 is a perspective view of a door arm in accordance with an embodiment of the present invention;

FIG. 2 is a top plan schematic view of an automatic door assembly of in accordance with a first embodiment of the present invention;

FIG. 3 is a top plan schematic view of an automatic door assembly of in accordance with a second embodiment of the present invention;

FIG. 4 is a top plan schematic view of an automatic door assembly of in accordance with a third embodiment of the present invention; and

FIG. 5 is a top plan schematic view of an automatic door assembly of in accordance with a fourth embodiment of the present invention.

### DETAILED DESCRIPTION OF THE ILLUSTRATED EMBODIMENT(s)

In the following description, various embodiments are illustrated. For convenience, similar structures between the various embodiments will be labeled with identical or similar reference numbers.

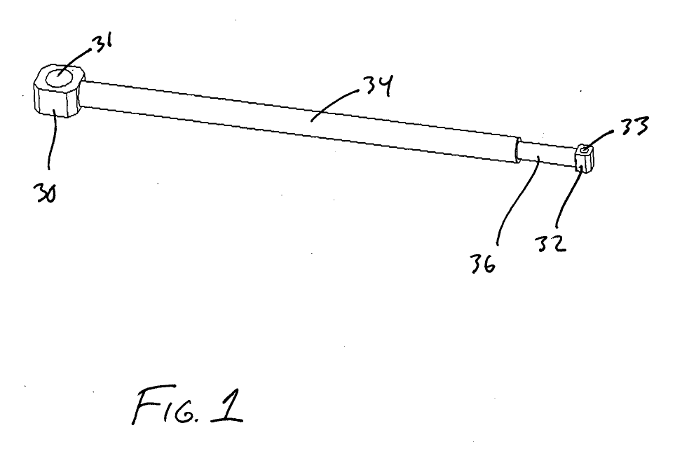

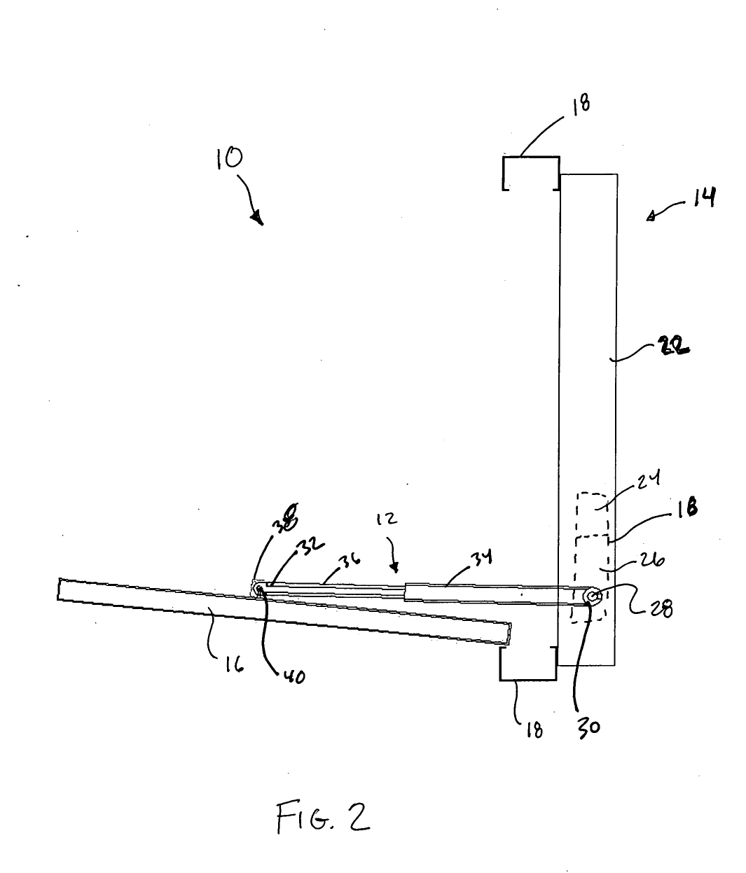

FIG. 1 shows a door arm 12 that is designed for use in an automatic door assembly. For convenience, the door arm 12 and its operation will be described primarily with reference to the automatic door assembly 10 illustrated in FIG. 2. The door assembly 10 may have any construction, but will generally have a frame 14, at least one door panel 16, and a door operator 18 for providing motive force.

The frame 14 may have any construction or configuration, and need not be limited to the construction illustrated. The illustrated embodiments are shown schematically, as the construction of such frames is well-known in the art and need not be detailed herein. Generally, the frame 14 will include a pair of generally vertical side stiles 20 and a header 22 extending horizontally between the side stiles 20 at the top of the frame 14. The frame generally delineates a doorway through which persons or objects will travel when the assembly 10 is installed in the opening of a building wall. The header 22 is a generally hollow case that encloses the door operator 18. In some embodiments, it is possible to omit the header 22, particularly if it is feasible to mount the operator within the building wall instead of within the header 22.

The door panel 16 is pivotally mounted by hinges (not shown) connected between the end of the panel 16 and one of the side stiles 18. The door panel 16 may have any construction or configuration, and such constructions are well-known and need not be detailed herein. The embodiment shown in FIG. 2 is commonly referred to as a swing door, as the door panel 16 pivots about an axis defined by the hinges at the end of the panel 16. Other mountings for the door panel 16 may be used, such as using pins at the top and bottom of the door panel 16 that are received in openings in the upper and lower portions of the frame 14 for providing such pivoting movement.

The operator 18 is shown as being housed within the header 22. The construction of such operators 18 is well-known, and need not be explained in detail. Typically, the operator 18 includes a motor 24 and a reduction transmission 26 comprising a plurality of gears. These parts of the operator 18 are shown schematically, as they are well-known, and any suitable operator 18 may be used. The reduction transmission 26 is coupled to a rotatable output member 28. The output member 28 rotates about a vertical axis, and may extend out from the bottom surface of the header 22.

The door arm 12 has opposing first and second end portions 30, 32. The first end portion 30 is fixedly connected to the rotatable output member 28 of the door operator 18 and the second end portion 32 is pivotally connected at a fixed point on the door panel 16. As a result, rotation of the output member 28 by the operator 18 pivots the door arm 12 to move the door panel 16.

Specifically, the first end portion 30 has a widened configuration with a bore 31 that receives the output member 28 of the operator 18. The internal surface of the bore 31 and the external surface of the output member 28 may be splined in a complementary manner so as to fixedly connect the first end portion 30 to the output member 28 for driving the door arm 12. In place of a splined connection, any other connection may be used, such as a radially oriented fastener, or any other connection. With respect to the second end portion 32, it also has a smaller head or widened configuration with a bore 33 there through. A bracket 38 is fixedly attached to the door panel 16 at any suitable location and provides a pivot pin 40 that is pivotally received in the bore 33. This pivotally connects the second end portion 32 to the door panel 16, and allows the end portion 32 to pivot freely relative to the pin 40 and the door panel 16. The bracket 38 and pin 40 may be located at any suitable location on the door panel 16.

The door arm 12 comprises at least two arm sections 34, 36 mounted to one another for relative rectilinear movement. The mounting may be as illustrated in FIG. 1, with one section being received inside another section in a telescoping manner. Also, the arm sections may be mounted for rectilinear movement in other manners, such as by coupling two sections together adjacent one another. Providing the ability for these sections 34, 36 to move rectilinearly to one another enables a length of the door arm 12 between the rotatable output member 28 and the fixed point on the door panel 16 to adjust for accommodating movement of the door panel 16. Thus, as the door operator 18 rotates the output member 28 to open the door panel 16, the door arm 12 is pivoted to push the door panel outwardly (to the position shown in FIG. 2), and the door arm 12 length adjusts to accommodate the change in distance between the output member 28 and the pivot pin 40 on bracket 38. The reverse action occurs as the door panel 16 returns to the closed position.

The door arm 12 may be used in a wide variety of door assembly installations, and need not be limited to the ones shown or described in this application.

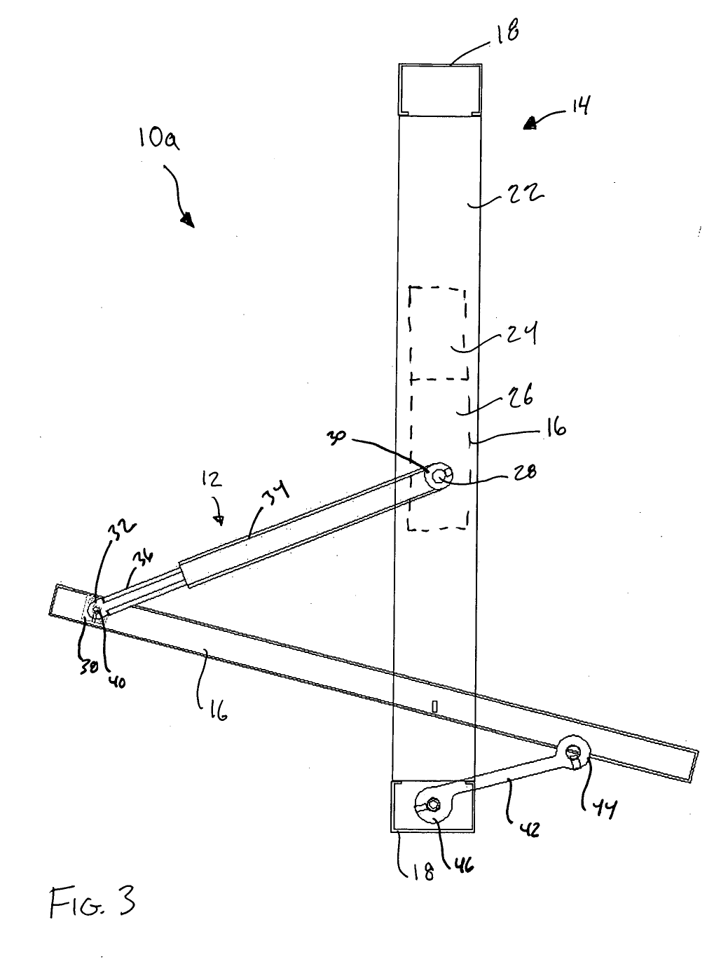

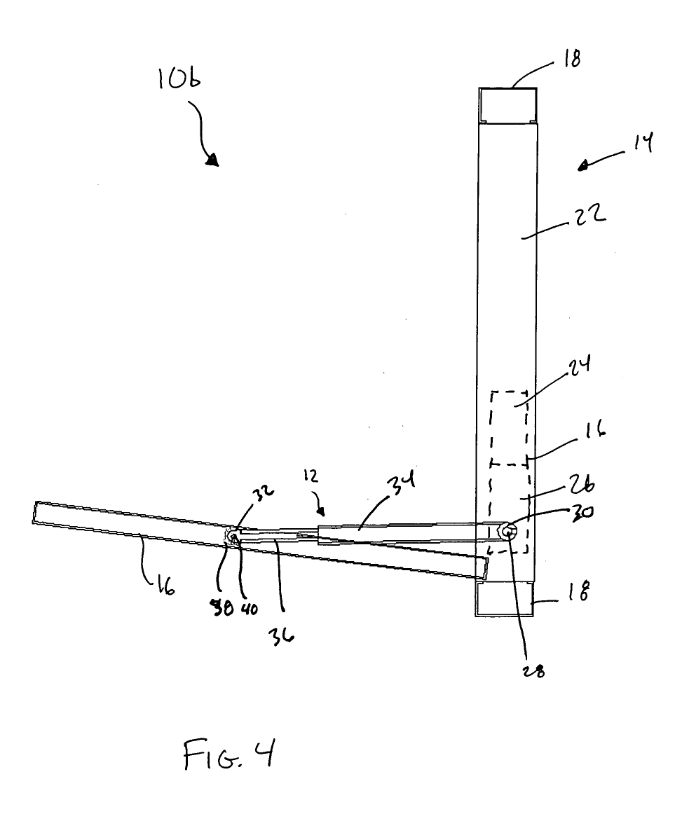

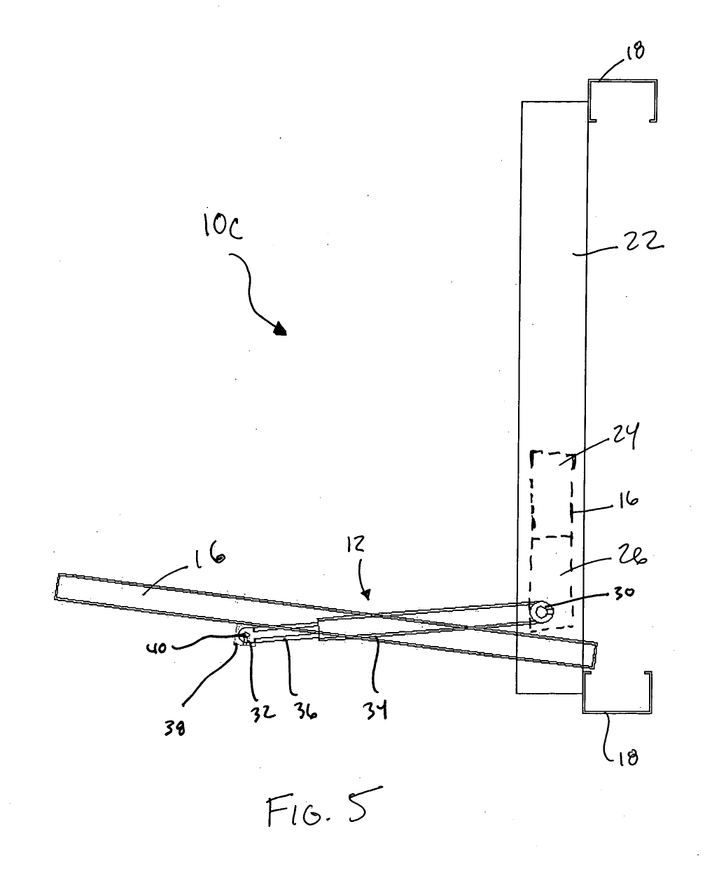

FIG. 2 shows the door arm 12 in the context of an outswing installation. In this installation, the bracket 38 is on the door panel surface that faces in the closing direction, and the header 22 is offset away from the opening direction of the door panel 16. This allows the door arm to extend at a slight angle under the header 22 and adjacent the door panel 16. FIG. 3 shows an alternative embodiment 10a where the door arm 12 is used in a balanced door installation. In this embodiment, the door panel 16 does not swing about hinges, and a second door arm 42 acts in a passive manner to control the swinging of the door panel 16. The second door arm 42 is pivotally connected at one end 44 to the door panel 16 and at another end 46 to the a stile 18. FIG. 4 shows an alternative embodiment where the header 22 is not offset from the stiles 18, and instead mounts directly above the stiles 18. In this embodiment, the bracket 38 is on the top surface of the door panel's top rail, and space is provided to allow the door arm 12 to be received directly between the header 22 and the panel 16 when the door panel 16 is in the closed position with the arm 12 extending parallel to the door panel's top rail. FIG. 5 shows another alternative embodiment where the door arm 12 is used in an inswing installation. This installation is similar to the one shown in FIG. 2, except that the bracket 38 is on the opposite surface of the door panel (i.e., the surface in the opening direction), and the header is offset in from the stiles 18 in the opening direction.

In any embodiment, the door arm 12, one or both of the arm second 32, 36 may be provided with a low friction material at regions where they contact one another. In the telescoping embodiment illustrated, that would be on either the exterior surface of arm section 36 or the interior surface of arm section 34, or both.

Likewise, in any embodiment the door arm 12 may be configured to assist in dampening the movement of the door panel 16.

The foregoing illustrated embodiments have been provided solely for illustrating the fictional and structural principles of the present invention, and are not intended to be limiting. To the contrary, the present invention is intended to encompass all modifications, substitutions, alterations, and equivalents within the spirit and scope of the following claims.

What is claimed:

1. An automatic door system comprising:
a frame;
at least one door panel mounted to the frame for swinging movements between open and closed positions;
a door operator comprising a motor and a rotatable output member, the motor being operable to rotate the output member under power;
a door arm having opposing first and second ends, the first end being fixedly connected to the rotatable output member of the door operator and the second end being pivotally connected at a fixed point on the door panel such that rotation of the output member by the operator pivots the door arm to move the door panel;
the door arm comprising at least two arm sections mounted to one another for relative rectilinear movement so as to enable a length of the door arm between the rotatable output member and the fixed point on the door panel to adjust for accommodating movement of the door panel.

2. An automatic door system according to claim 1, further comprising a header, the door operator being mounted within the header.

3. An automatic door system according to claim 1, wherein the arm sections are mounted to one another in a telescoping manner.

4. An automatic door assembly according to claim 3, wherein the arm sections are tubular.

5. An automatic door assembly according to claim 1, wherein the at least two arm sections include only two arm sections.

6. An automatic door assembly according to claim 1, wherein the second end of the door arm is pivotally connected to the door panel by a pivot pin.
